(19) United States
(12) Patent Application Publication
(10) Pub. No.: US 2016/0239249 A1
(43) Pub. Date: Aug. 18, 2016

(54) MULTI-DISPLAY DEVICE

(71) Applicant: Samsung Electronics Co., Ltd., Suwon-si (KR)

(72) Inventors: Seung-Gun LEE, Hwaseong-si (KR); Seung-Pyo HONG, Seoul (KR); Soung-Min HWANG, Hwaseong-si (KR)

(21) Appl. No.: 15/002,001

(22) Filed: Jan. 20, 2016

(30) Foreign Application Priority Data
Feb. 12, 2015 (KR) 10-2015-0021530

(51) Int. Cl. G06F 3/14; G09G 3/20

(52) U.S. Cl. CPC G06F 3/1431; G06F 3/1446; G09G 3/2096; G09G 2310/061; G09G 2310/08

(57) ABSTRACT

A multi-display device includes a plurality of display modules and a host controller. Each of the display modules includes a display panel and a display driving integrated circuit and performs a display panel self-refresh operation. The host controller controls the display modules and provides image data for displaying an image to the display modules. The display modules are classified into a master display module and slave display modules that adjust a vertical blank period based on a reference tearing effect control signal output from the master display module. Thus, the multi-display device can mitigate or prevent a tearing effect from occurring between the display modules without changing an interface between the host controller and the display modules.

### CROSS-REFERENCE TO RELATED APPLICATION(S)

This application claims priority under 35 USC §119 to Korean Patent Application No. 10-2015-0021530, filed on Feb. 12, 2015 in the Korean Intellectual Property Office (KIPO), the contents of which are incorporated herein in its entirety by reference.

### BACKGROUND

1. Technical Field

At least some example embodiments relate to a multi-display device. More particularly, some example embodiments of the present inventive concepts relate to a multi-display device that performs a display panel self-refresh operation.

2. Description of the Related Art

Generally, an electronic device includes a display device that provides a user with visual information, and a substantial portion of power consumed by the electronic device is caused by the display device. For this reason, a display device that can consume low power by performing a display panel self-refresh operation when displaying a still image has been suggested. Further, a multi-display device, in which a plurality of display modules each including a display panel and a display driving integrated circuit (DDIC) are connected to satisfy various requirements of users, has received attention. According to manners of connecting the display modules, the multi-display device may have an extended shape (i.e., implementing a large screen), a foldable shape, a flexible shape, etc.

In conventional multi-display devices, because reference clock signals generated by, for example, respective internal oscillators differ between the display modules, at least two signals (e.g., scan signals) used in the display modules may not be synchronized. Accordingly, a tearing effect (e.g., image breaks or visual artifacts) may occur between the display modules when a display operation is performed. Some conventional multi-display devices synchronize operations of the display modules by using tearing effect control signals output respectively from the display modules. However, because the conventional multi-display devices use software and/or hardware components for synchronizing the operations of the display modules (i.e., for synchronizing operations of display driving integrated circuits included in the display modules), overall structures of the conventional multi-display devices may be complicated, and performance of the conventional multi-display devices may be degraded.

### SUMMARY

Some example embodiments provide a multi-display device that can mitigate or prevent a tearing effect from occurring between display modules without changing an interface between a host controller (e.g., an application processor (AP)) and the display modules. The multi-display device may include the plurality of display modules each including a display panel and a display driving integrated circuit and the host controller that controls the display modules.

According to an example embodiment, a multi-display device includes a plurality of display modules including a plurality of display panels and a plurality of display driving integrated circuits, respectively, the plurality of display modules configured to perform a display panel self-refresh operation, one of the display modules being a master display module and the rest of the display modules being slave display modules, the slave display modules configured to adjust a vertical blank period thereof based on a reference tearing effect control signal output from the master display module, and a host controller configured to control the display modules and provide image data to the display modules.

In some example embodiments, the master display module may be selected from among the display modules based on a master selection signal received from an external component or an algorithm, which is stored in a non-transitory computer-readable medium and is configured to be executed by a processor.

In some example embodiments, each of the display modules may is configured to generate a tearing effect control signal and may include an input/output terminal for sharing the tearing effect control signal among the display modules. Further, the tearing effect control signal generated by the master display module from among the display modules may be determined as the reference tearing effect control signal.

In some example embodiments, the master display module may be configured to perform a display operation and some or all of the slave display modules may be configured to perform the display operation when the multi-display device operates.

In some example embodiments, each of the slave display modules may be configured to set a vertical blank start point of the vertical blank period to be a reference vertical blank start point indicated by the reference tearing effect control signal.

In some example embodiments, each of the slave display modules may be configured to compare a vertical blank end point of the vertical blank period with a reference vertical blank end point indicated by the reference tearing effect control signal in each frame and may be configured to count an interval between the vertical blank end point and the reference vertical blank end point with an internal clock signal.

In some example embodiments, each of the slave display modules may be configured to move the vertical blank end point to be placed before the reference vertical blank end point in a (k+1)th frame, where k is an integer greater than or equal to 1, when the vertical blank end point is placed after the reference vertical blank end point in a (k)th frame.

In some example embodiments, each of the slave display modules may be configured to move the vertical blank end point to be placed at the reference vertical blank end point or before the reference vertical blank end point by decreasing the vertical blank period by more than a number of counted clocks of the internal clock signal.

In some example embodiments, each of the slave display modules may be configured to move the vertical blank end point to be placed at the reference vertical blank end point or before the reference vertical blank end point by decreasing the vertical blank period by decreasing a horizontal blank period.

In some example embodiments, each of the slave display modules may be configured to maintain the vertical blank end point in a (k+1)th frame, where k is an integer greater than or equal to 1, when the vertical blank end point is placed at the reference vertical blank end point or before the reference vertical blank end point in a (k)th frame.

In some example embodiments, each of the slave display modules may be configured to move the vertical blank end point to a selection point that precedes the reference vertical blank end point by a distance in a (k+1)th frame, where k is an integer greater than or equal to 1, when the vertical blank end point is placed before the reference vertical blank end point in a (k)th frame.

In some example embodiments, each of the slave display modules may be configured to move the vertical blank end point to the selection point by increasing the vertical blank period.

In some example embodiments, each of the slave display modules may be configured to move the vertical blank end point to the selection point by increasing the vertical blank period by increasing a horizontal blank period.

In some example embodiments, the multi-display device may be configured to operate based on a point-to-point interface, which enables the host controller to separately provide the image data to the display modules.

In some example embodiments, the multi-display device may be configured to operate based on a multi-drop interface, which enables the host controller to concurrently provide the image data to the display modules.

According to an example embodiment, an electronic device includes a main processor, a memory device, and a multi-display device. The multi-display device may include a plurality of display modules each including a display panel and a display driving integrated circuit and configured to perform a display panel self-refresh operation and a host controller configured to control the display modules and to provide image data for displaying an image to the display modules. Here, the display modules may be classified into a master display module and slave display modules that adjust a vertical blank period based on a reference tearing effect control signal output from the master display module.

In some example embodiments, each of the slave display modules may be configured to set a vertical blank start point of the vertical blank period to be a reference vertical blank start point indicated by the reference tearing effect control signal. Further, each of the slave display modules may be configured to compare a vertical blank end point of the vertical blank period with a reference vertical blank end point indicated by the reference tearing effect control signal in each frame and may be configured to count an interval between the vertical blank end point and the reference vertical blank end point with an internal clock signal.

In some example embodiments, each of the slave display modules may be configured to move the vertical blank end point to be placed at the reference vertical blank end point or before the reference vertical blank end point in a (k+1)th frame, where k is an integer greater than or equal to 1, when the vertical blank end point is placed after the reference vertical blank end point in a (k)th frame.

In some example embodiments, each of the slave display modules may be configured to maintain the vertical blank end point in a (k+1)th frame, where k is an integer greater than or equal to 1, when the vertical blank end point is placed at the reference vertical blank end point or before the reference vertical blank end point in a (k)th frame.

In some example embodiments, each of the slave display modules may be configured to move the vertical blank end point to a selection point that precedes the reference vertical blank end point by a distance in a (k+1)th frame, where k is an integer greater than or equal to 1, when the vertical blank end point is placed before the reference vertical blank end point in a (k)th frame.

According to an example embodiment, a multi-display device including a plurality of display modules each including a display panel and a display driving integrated circuit and configured to perform a display panel self-refresh operation, includes a master display module selected from among the display modules, the master display module configured to output a reference tearing effect control signal, at least one slave display module configured to adjust a vertical blank period based on the reference tearing effect control signal, and a host controller configured to control the display modules and provide image data to the display modules,

In some example embodiments, the master display module may be selected from among the display modules based on a master selection signal received from an external component or an algorithm, which is stored in a non-transitory computer-readable medium and is configured to be executed by a processor.

In some example embodiments, the at least one slave display module may be configured to set a vertical blank start point of the vertical blank period to be a reference vertical blank start point indicated by the reference tearing effect control signal, compare a vertical blank end point of the vertical blank period with a reference vertical blank end point indicated by the reference tearing effect control signal in each frame, count an interval between the vertical blank end point and the reference vertical blank end point with an internal clock signal, and at least one of move and maintain the vertical blank end point in a (k+1)th frame, where k is an integer greater than or equal to 1, with respect to the reference vertical blank end point depending on whether the vertical blank end point is placed before, at, or after the reference vertical blank end point in a (k)th frame.

In some example embodiments, when the vertical blank end point may be placed before the reference vertical blank end point in the (k)th frame, the at least one slave display module is configured to move the vertical blank end point to a selection point, which precedes the reference vertical blank end point, in the (k+1)th frame by one of increasing the vertical blank period and increasing the vertical blank period by increasing a horizontal blank period.

In some example embodiments, when the interval in the (k)th frame is smaller than a threshold value, the at least one slave display module is configured to maintain the vertical blank period in the (k+1)th frame.

Accordingly, a multi-display device according to example embodiments may include display modules each including a display panel and a display driving integrated circuit and a host controller that controls the display modules. Here, the multi-display device may mitigate or prevent a tearing effect from occurring between the display modules without the need of changing an interface between the host controller and the display modules by adjusting vertical blank periods of slave display modules based on a reference tearing effect control signal received from a master display module that is selected (or, chosen) among the display modules.

### BRIEF DESCRIPTION OF THE DRAWINGS

Illustrative, non-limiting example embodiments will be more clearly understood from the following detailed description in conjunction with the accompanying drawings.

FIG. 1 is a block diagram illustrating a multi-display device according to an example embodiment.

FIG. 2A is a block diagram illustrating an example in which the multi-display device of FIG. 1 is configured to operate based on a point-to-point interface.

FIG. 2B is a block diagram illustrating an example in which the multi-display device of FIG. 1 is configured to operate based on a multi-drop interface.

FIG. 3 is a diagram illustrating an operation of the multi-display device of FIG. 1 according to an example embodiment.

FIG. 4 is a flowchart illustrating a process in which a slave display module adjusts a vertical blank period in the multi-display device of FIG. 1.

FIG. 5 is a timing diagram illustrating an example in which a slave display module decreases (or, shortens) a vertical blank period in the multi-display device of FIG. 1.

FIG. 6 is a timing diagram illustrating an example in which a slave display module maintains a vertical blank period in the multi-display device of FIG. 1.

FIG. 7 is a timing diagram illustrating an example in which a slave display module increases a vertical blank period in the multi-display device of FIG. 1.

FIG. 8 is a flowchart illustrating an example in which a slave display module moves a vertical blank end point of a vertical blank period in the multi-display device of FIG. 1.

FIG. 9 is a flowchart illustrating another example in which a slave display module moves a vertical blank end point of a vertical blank period in the multi-display device of FIG. 1.

FIG. 10 is a flowchart illustrating still another example in which a slave display module moves a vertical blank end point of a vertical blank period in the multi-display device of FIG. 1.

FIG. 11 is a block diagram illustrating an electronic device according to an example embodiment.

FIG. 12 is a diagram illustrating an example in which the electronic device of FIG. 11 is implemented as a smart phone.

### DETAILED DESCRIPTION

Various example embodiments will be described more fully with reference to the accompanying drawings, in which some example embodiments are shown. The present inventive concepts may, however, be embodied in many different forms and should not be construed as limited to the example embodiments set forth herein. Rather, these example embodiments are provided so that this disclosure will be thorough and complete, and will fully convey the scope of the present inventive concepts to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present inventive concepts. As used herein, the term “and/or” includes any and all combinations of one or more of the associated listed items.

It will be understood that when an element is referred to as being “on,” “connected to,” or “coupled to” another element, it can be directly connected or coupled to the other element or intervening elements may be present. In contrast, when an element is referred to as being “directly on,” “directly connected to,” or “directly coupled to” another element, there are no intervening elements present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. Expressions such as “at least one of,” when preceding a list of elements, modify the entire list of elements and do not modify the individual elements of the list.

The terminology used herein is for the purpose of describing particular example embodiments and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Meanwhile, when it is possible to implement any example embodiment in any other way, a function or an operation specified in a specific block may be performed differently from a flow specified in a flowchart. For example, two consecutive blocks may actually perform the function or the operation simultaneously, and the two blocks may perform the function or the operation conversely according to a related operation or function.

Unless otherwise defined, all terms (including technical and scientific terms) used herein have the same meaning as commonly understood by one of ordinary skill in the art to which this inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, some example embodiments will be explained in further detail with reference to the accompanying drawings.

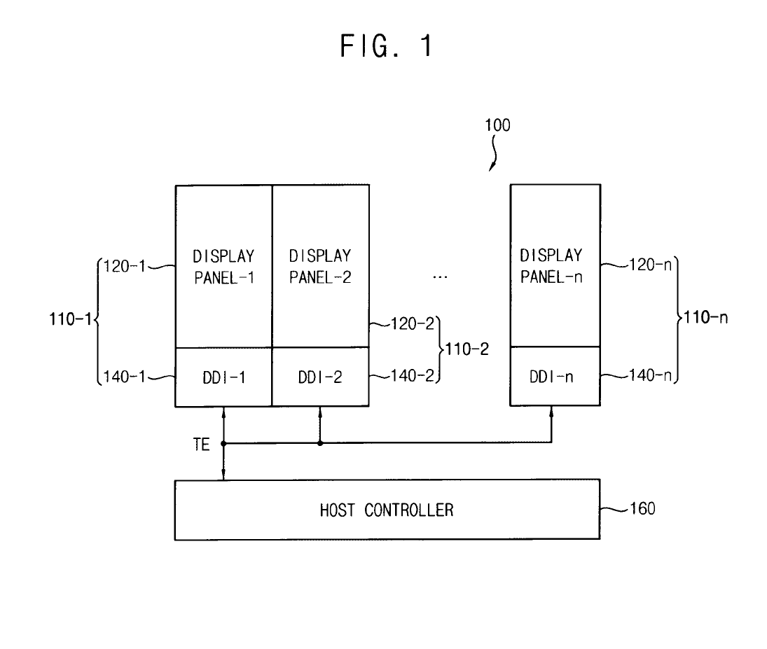

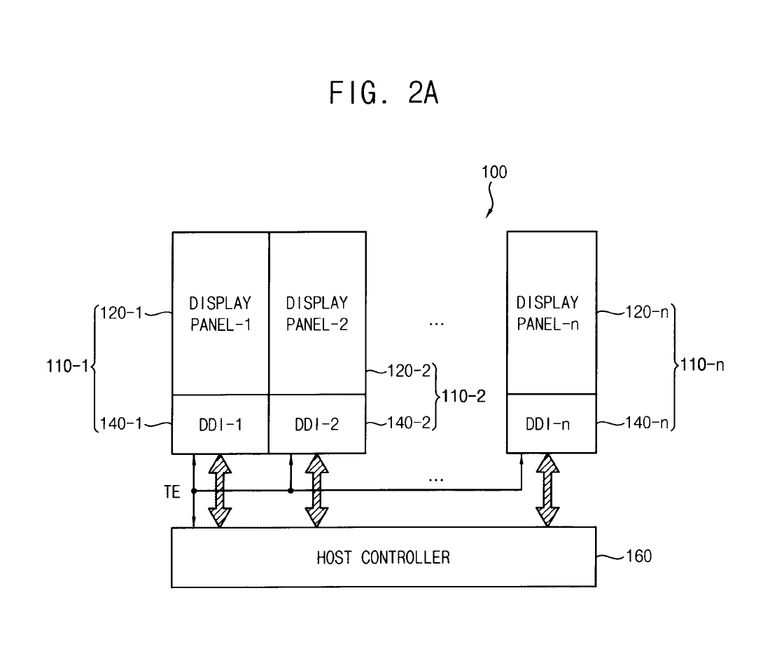

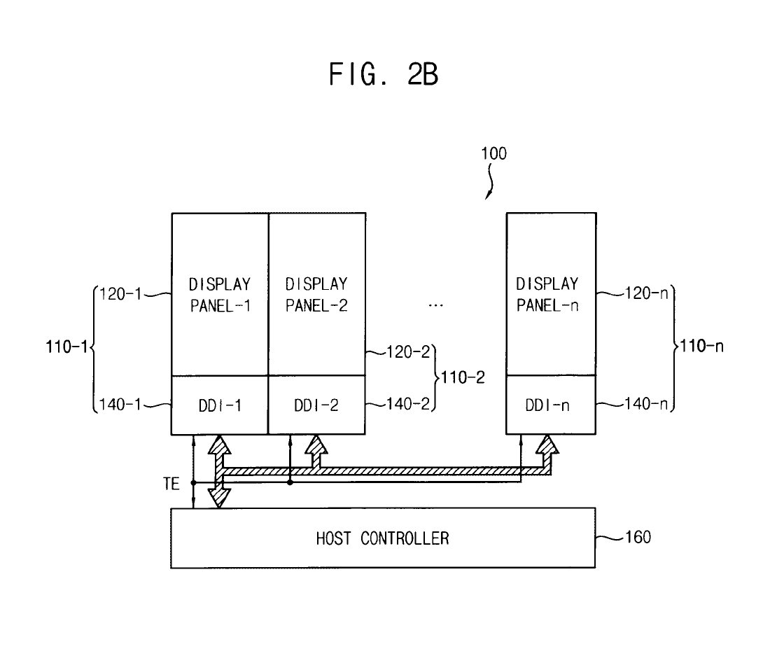

FIG. 1 is a block diagram illustrating a multi-display device according to an example embodiment. FIG. 2A is a block diagram illustrating an example in which the multi-display device of FIG. 1 is configured to operate based on a point-to-point interface. FIG. 2B is a block diagram illustrating an example in which the multi-display device of FIG. 1 is configured to operate based on a multi-drop interface. FIG. 3 is a diagram illustrating an operation of the multi-display device the multi-display device of FIG. 1 according to an example embodiment.

Referring to FIGS. 1 through 3, the multi-display device 100 may include a plurality of display modules 110-1 through 110-n, where n is an integer greater than or equal to 2, and a host controller 160. For example, the host controller 160 may be an application processor (AP). The host controller 160 may communicate with the display modules 110-1 through 110-n based on a specific interface. In an example embodiment, as illustrated in FIG. 2A, the multi-display device 100 may operate based on a point-to-point interface, which enables the host controller 160 to separately or individually provide image data to the display modules 110-1 through 110-n. In another example embodiment, as illustrated in FIG. 2B, the multi-display device 100 may operate based on a multi-drop interface, which enables the host controller 160 to concurrently or simultaneously provide the image data to the display modules 110-1 through 110-n.

The display module 110-j, where j is an integer between 1 and n, may include a display panel 120-j and a display driving integrated circuit 140-j. The display module 110-j may be configured to consume low power by performing a display panel self-refresh operation when displaying a still image. Here, the display panel 120-j may be a so-called IGZO display panel that uses Indium-Gallium-Zinc-Oxide (IGZO) thin film transistors. However, the display panel 120-j is not limited thereto. The display panel 120-j may include a plurality of pixels for displaying an image. The display panel 120-j may be connected to a scan driver included in the display driving integrated circuit 140-j via a plurality of scan-lines and may be connected to a data driver included in the display driving integrated circuit 140-j via a plurality of data-lines. Here, the pixels of the display panel 120-j may be arranged at locations corresponding to intersection points of the scan-lines and the data-lines. The display driving integrated circuit 140-j may include the scan driver, the data driver, a timing controller, a frame buffer, etc. The scan driver of the display driving integrated circuit 140-j may provide scan signals to the display panel 120-j. The data driver of the display driving integrated circuit 140-j may provide data signals corresponding to the image data to the display panel 120-j. The timing controller of the display driving integrated circuit 140-j may control timings of the scan driver and the data driver of the display driving integrated circuit 140-j. The frame buffer of the display driving integrated circuit 140-j may temporarily store the image data applied from an external component (e.g., the host controller 160) by frame units and then may provide the image data to the data driver of the display driving integrated circuit 140-j.

The host controller 160 may control the display modules 110-1 through 110-n. The host controller 160 may provide the image data for displaying an image to the display modules 110-1 through 110-n. As described above, when the display module 110-j displays the still image, an image displayed on the display panel 120-j is not changed. Thus, when the display module 110-j displays the still image, an interface between the host controller 160 and the display module 110-j may not operate. In this case, the host controller 160 may not provide the image data to the display module 110-j. However, the display module 110-j may continue to perform a display operation based on the image data stored in a frame memory of the display driving integrated circuit 140-j. Next, when displaying a new image is desired due to various factors (e.g., a user command, etc.), the interface between the host controller 160 and the display module 110-j may operate, and thus the host controller 160 may provide new image data for displaying the new image to the display module 110-j. Here, when a scan operation timing of the scan driver overlaps an update operation timing of the frame memory in the display driving integrated circuit 140-j, a tearing effect (e.g., image breaks or visual artifacts) may occur. A tearing effect is visual artifact(s) or image break(s) in video display where a display module shows information from two or more frames in a single screen draw. This effect can occur due to non-matching refresh rates—in which case the tear line moves as the phase difference changes (with speed proportional to difference of frame rates) or simply due to lack of synchronization between, for example, equal frame rates. Thus, to mitigate or prevent the tearing effect from occurring, the display driving integrated circuit 140-j of the display module 110-j may provide a tearing effect control signal TE to the host controller 160, and the host controller 160 may provide new image data to the display driving integrated circuit 140-j by adjusting a data transmission timing based on the tearing effect control signal TE. Nevertheless, because reference clock signals generated by, for example, respective internal oscillators differ between the display modules 110-1 through 110-n, at least two signals (e.g., scan signals) used in the display modules 110-1 through 110-n may not be synchronized. Accordingly, the tearing effect may occur between the display modules 110-1 through 110-n when the display operation is performed.

According to some example embodiments of the present inventive concepts, in the multi-display device 100, the display modules 110-1 through 110-n may be classified into a master display module and slave display modules, and each of the slave display modules may adjust its vertical blank period based on a reference tearing effect control signal TE received from the master display module. Thus, the multi-display device 100 may mitigate or prevent the tearing effect from occurring between the display modules 110-1 through 110-n. For example, one of the display modules 110-1 through 110-n may be selected as the master display module based on a master selection signal (now shown) received from an external component or a set (or alternatively, predetermined) algorithm, and the rest (e.g., non-selected ones) of the display modules 110-1 through 110-n may be determined as the slave display modules. For example, the master selection signal may be provided via the host controller 160. The set (or alternatively, predetermined) algorithm may be included (or, embedded) in the host controller 160. Accordingly, a classification between the master display module and the slave display modules may not be fixed. For example, the classification between the master display module and the slave display modules may change based on the master selection signal or the set (or alternatively, predetermined) algorithm. As described above, each of the display modules 110-1 through 110-n may generate the tearing effect control signal TE and may share the tearing effect control signal TE with other display modules 110-1 through 110-n. For example, each of display modules 110-1 through 110-n may provide the tearing effect control signal TE to other display modules 110-1 through 110-n via input/output (I/O) terminals (e.g., I/O ports, I/O pins, etc.) (not shown) and may receive the tearing effect control signal TE from other display modules 110-1 through 110-n via the input/output (I/O) terminals. In conventional multi-display devices, display modules do not share a tearing effect control signal (i.e., each of the display modules only outputs the tearing effect control signal). In the multi-display device 100 according to some example embodiments, the display modules 100-1 through 100-n may be configured to share the tearing effect control signals TE with each other. In the multi-display device 100 according to some example embodiments, the tearing effect control signals TE generated by a selected one (e.g., the master display module) of the display modules 110-1 through 110-n may be determined as the reference tearing effect control signal TE. For example, the tearing effect control signal TE generated by the master display module may be provided to non-selected ones (i.e., the slave display modules) of the display modules 110-1 through 110-n as the reference tearing effect control signal TE. In other words, the reference tearing effect control signal TE may be shared by the display modules 110-1 through 110-n. In some example embodiments, when the multi-display device 100 operates, some of the slave display modules may not perform the display operation while the master display module performs the display operation based on the reference tearing effect control signal TE.

FIG. 3 shows an operation of the multi-display device 100 according to an example embodiment. For convenience of description, it is assumed in FIG. 3 that the multi-display device 100 includes two display modules 110-1 and 110-2, the first display module 110-1 is selected as a master display module, and the second display module 110-2 is determined as a slave display module. As illustrated in FIG. 3, the master display module 110-1 may provide the reference tearing effect control signal TE to the slave display module 110-2 and the host controller 160. The slave display module 110-2 may adjust its vertical blank period based on the reference tearing effect control signal TE (as indicated by AD), and the host controller 160 may adjust a data transmission timing of image data MDT to be provided to the master display module 110-1 and a data transmission timing of image data SDT to be provided to the slave display module 110-2 based on the reference tearing effect control signal TE (as indicated by BD). In conventional multi-display devices, a host controller receives tearing effect control signals from respective all display modules. Thus, the host controller is desired to include software and/or hardware components for synchronizing operations of the display modules (e.g., for synchronizing operations of display driving integrated circuits included in the display modules). In the multi-display device 100 according to the example embodiment, the host controller 160 may adjust the data transmission timings of the image data MDT to be provided to the master display module 110-1 and the image data SDT to be provided to the slave display module 110-2 based on the reference tearing effect control signal TE that the master display module 110-1 provides (e.g., based on one tearing effect control signal provided by one display module). Thus, the host controller 160 does not need to include software and/or hardware components for synchronizing the operations of the display modules 110-1 and 110-2. Accordingly, in the multi-display device 100 according to the example embodiment, conventional host controllers may be used as the host controller 160, and/or conventional interface may be used as an interface between the host controller 160 and the display modules 110-1 and 110-2.

According to the example embodiment, the host controller 160 can adjust the data transmission timings of the image data MDT to be provided to the master display module 110-1 and the image data SDT to be provided to the slave display module 110-2, for example, solely based on the reference tearing effect control signal TE from the master display module 110-1 because the slave display module 110-2 can adjust its vertical blank period based on the reference tearing effect control signal TE from the master display module 110-1. For example, the slave display module 110-2 may set a vertical blank start point of its vertical blank period to be a reference vertical blank start point indicated by the reference tearing effect control signal TE. In each of the display modules 110-1 and 110-2, because the tearing effect control signal TE corresponds to the vertical blank period, the vertical blank period (i.e., the vertical blank start point and the vertical blank end point) may be obtained (or, figured out) from the tearing effect control signal TE. Next, the slave display module 110-2 may compare the vertical blank end point of its vertical blank period with the reference vertical blank end point indicated by the reference tearing effect control signal TE in each frame, and may count an interval between the vertical blank end point and the reference vertical blank end point with an internal clock signal. For example, the slave display module 110-2 may move the vertical blank end point to be placed at the reference vertical blank end point or before the reference vertical blank end point in a (k+1)th frame when the vertical blank end point is placed after the reference vertical blank end point in a (k)th frame. Thus, the vertical blank period of the slave display module 110-2 may be decreased in the (k+1)th frame. In an example embodiment, the slave display module 110-2 may move the vertical blank end point to be placed at the reference vertical blank end point or before the reference vertical blank end point by decreasing its vertical blank period by more than the number of counted clocks of the internal clock signal. In another example embodiment, the slave display module 110-2 may move the vertical blank end point to be placed at the reference vertical blank end point or before the reference vertical blank end point by decreasing its vertical blank period by decreasing a horizontal blank period.

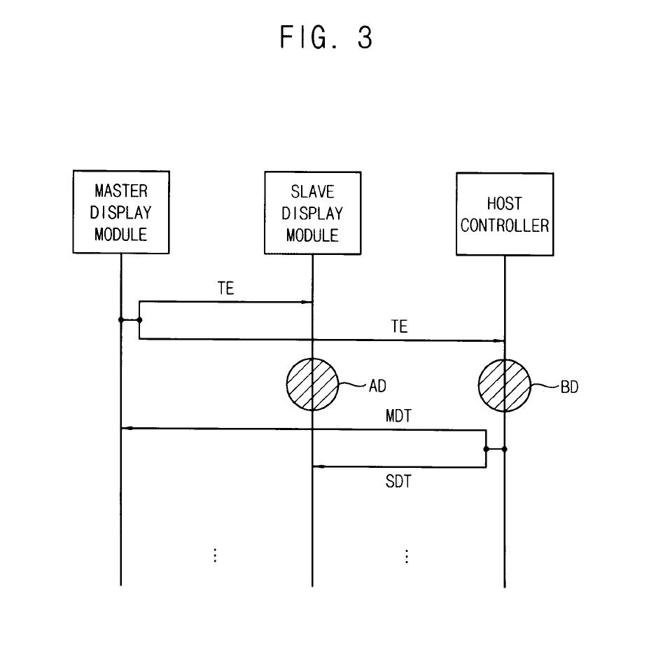

According to some example embodiments, the slave display module 110-2 may maintain the vertical blank end point in the (k+1)th frame when the vertical blank end point is placed at the reference vertical blank end point or before the reference vertical blank end point in the (k)th frame. In other words, the slave display module 110-2 may maintain its vertical blank period when the vertical blank end point is placed at the reference vertical blank end point or before the reference vertical blank end point. In some example embodiments, the slave display module 110-2 may move the vertical blank end point to a selection point that precedes the reference vertical blank end point by a desired (or alternatively, set or predetermined) distance in the (k+1)th frame when the vertical blank end point is placed before the reference vertical blank end point in the (k)th frame. As a result, the vertical blank period of the slave display module 110-2 may be increased in the (k+1)th frame. That is, when a distance (or, difference) between the vertical blank end point and the reference vertical blank end point is longer than the desired (or alternatively, predetermined) number of clocks of the internal clock signal, although the vertical blank end point is placed before the reference vertical blank end point, the slave display module 110-2 may increase its vertical blank period as long as the vertical blank end point is placed before the reference vertical blank end point. In an example embodiment, the slave display module 110-2 may move the vertical blank end point to the selection point that precedes the reference vertical blank end point by the desired (or alternatively, predetermined) distance by increasing its vertical blank period. In another example embodiment, the slave display module 110-2 may move the vertical blank end point to the selection point that precedes the reference vertical blank end point by the desired (or alternatively, predetermined) distance by increasing its vertical blank period by increasing the horizontal blank period. An operation in which the slave display module 110-2 adjusts its vertical blank period based on the reference tearing effect control signal TE received from the master display module 110-1 will be described in detail with reference to FIGS. 4 through 10.

In brief, the multi-display device 100 may include the display modules 110-1 through 110-n including the display panels 120-1 through 120-n and the display driving integrated circuits 140-1 through 140-n and the host controller 160 that controls the display modules 110-1 through 110-n. The multi-display device 100 may mitigate or prevent the tearing effect from occurring between the display modules 110-1 through 110-n without changing the interface between the host controller 160 and the display modules 110-1 through 110-n, but instead by adjusting the vertical blank periods of the slave display modules (i.e., by ensuring a sufficient vertical blank period required for frame synchronization between the display modules 110-1 through 110-n) based on the reference tearing effect control signal TE received from the master display module selected from among the display modules 110-1 through 110-n. Accordingly, the multi-display device 100 may perform an image data update, using one tearing effect control signal TE, without the tearing effect on the display modules 110-1 through 110-n. Further, the multi-display device 100 may automatically perform frame synchronization between the display modules 110-1 through 110-n using one tearing effect control signal TE. Thus, when operating frequencies of the display modules 110-1 through 110-n are substantially the same, the multi-display device 100 may operate properly although resolutions of the display modules 110-1 through 110-n are different from each other. Further, even when only some of the display modules 110-1 through 110-n operate, the multi-display device 100 may perform the frame synchronization between some of the display modules 110-1 through 110-n without any involvement of the host controller 160. The multi-display device 100 may be implemented as a liquid crystal display (LCD) device, an organic light emitting display (OLED) device, etc. In some example embodiments, the multi-display device 100 may further include other components according to types of the multi-display device 100.

FIG. 4 is a flowchart illustrating a process in which a slave display module adjusts a vertical blank period in the multi-display device of FIG. 1.

Referring to FIG. 4, the slave display module may adjust its vertical blank period based on the reference tearing effect control signal received from the master display module. For example, the slave display module may set the vertical blank start point of its vertical blank period to be the reference vertical blank start point indicated by the reference tearing effect control signal received from the master display module (S110). Next, the slave display module may compare the vertical blank end point of its vertical blank period with the reference vertical blank end point indicated by the reference tearing effect control signal in each frame (S120). In some example embodiments, the slave display module may count an interval between the vertical blank end point of its vertical blank period and the reference vertical blank end point indicated by the reference tearing effect control signal with an internal clock signal. Then, the slave display module may check whether the reference vertical blank end point indicated by the reference tearing effect control signal is placed before the vertical blank end point of its vertical blank period in a current frame (S130). Here, when the reference vertical blank end point indicated by the reference tearing effect control signal is placed before the vertical blank end point of its vertical blank period (i.e., the vertical blank end point of its vertical blank period is placed after the reference vertical blank end point indicated by the reference tearing effect control signal) in a current frame, the slave display module may move the vertical blank end point of its vertical blank period to be placed before the reference vertical blank end point indicated by the reference tearing effect control signal in a next frame (S140). When the vertical blank end point of its vertical blank period is placed at the reference vertical blank end point indicated by the reference tearing effect control signal or before the reference vertical blank end point indicated by the reference tearing effect control signal in a current frame, the slave display module may maintain the vertical blank end point of its vertical blank period or may move the vertical blank end point of its vertical blank period to a selection point that precedes the reference vertical blank end point indicated by the reference tearing effect control signal by a desired (or alternatively, predetermined) distance in a next frame (S150). As described above, the slave display module may mitigate or prevent the tearing effect from occurring between the master display module and the slave display module SDM or between the slave display modules SDM by controlling the vertical blank end point of its vertical blank period to be placed at the reference vertical blank end point indicated by the reference tearing effect control signal or before the reference vertical blank end point indicated by the reference tearing effect control signal. Further, because the slave display module SDM compares the vertical blank end point of its vertical blank period with the reference vertical blank end point indicated by the reference tearing effect control signal in each frame to reflect the comparison result in a next frame, the vertical blank period of the slave display module SDM may not be abruptly changed as an operating environment is changed by various factors (e.g., temperature changes, etc.). Accordingly, a user may not perceive or sense a change of the vertical blank period of the slave display module SDM.

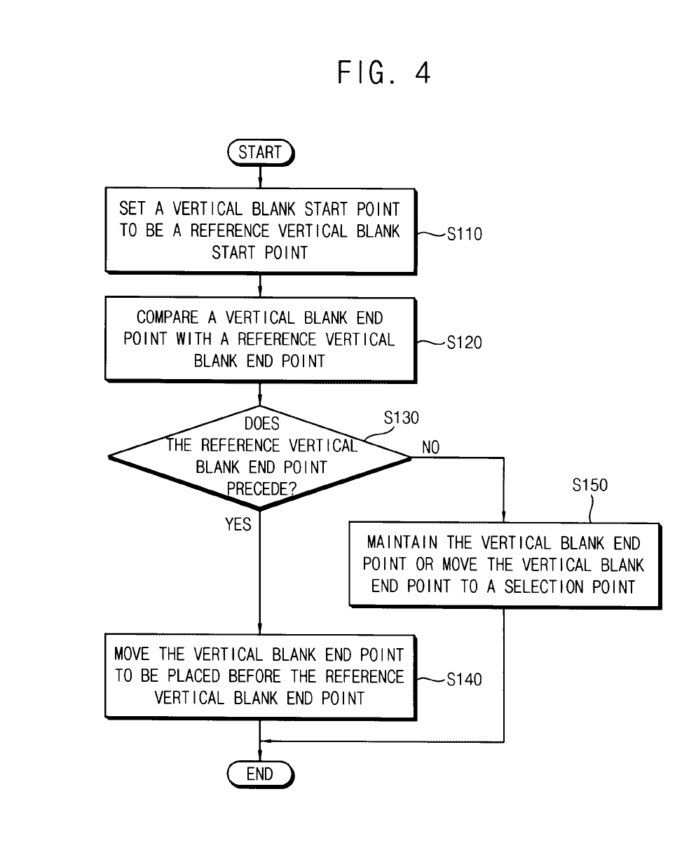

FIG. 5 is a timing diagram illustrating an example in which a slave display module decreases a vertical blank period in the multi-display device of FIG. 1.

Referring to FIG. 5, the tearing effect control signal S-TE of the master display module MDM (e.g., the reference tearing effect control signal TE) may correspond to the vertical blank period VBP of the master display module MDM (e.g., the reference vertical blank period VBP). Further, the tearing effect control signal S-TE of the slave display module SDM may correspond to the vertical blank period SVBP of the slave display module SDM. Thus, the reference vertical blank period VBP (e.g., the reference vertical blank start point and the reference vertical blank end point) may be obtained from the reference tearing effect control signal TE (e.g., the tearing effect control signal S-TE of the master display module MDM). Further, the vertical blank period SVBP of the slave display module SDM (e.g., the vertical blank start point and the vertical blank end point) may be obtained from the tearing effect control signal S-TE of the slave display module SDM. FIG. 5 shows an example in which the internal clock signal of the master display module MDM (e.g., a clock signal generated by an internal oscillator included in the master display module MDM) is relatively fast and the internal clock signal of the slave display module SDM (e.g., a clock signal generated by an internal oscillator included in the slave display module SDM) is relatively slow.

For example, when the reference vertical blank end point of the reference vertical blank period VBP indicated by the reference tearing effect control signal TE is placed before the vertical blank end point of the vertical blank period SVBP of the slave display module SDM (e.g., the vertical blank end point of the vertical blank period SVBP of the slave display module SDM is placed after the reference vertical blank end point of the reference vertical blank period VBP) in a current frame (as indicated by 1ST FRAME), the slave display module SDM may move the vertical blank end point of the vertical blank period SVBP of the slave display module SDM to be placed before the reference vertical blank end point of the reference vertical blank period VBP indicated by the reference tearing effect control signal TE in a next frame (as indicated by 2ND FRAME). In other words, when the reference vertical blank end point of the reference vertical blank period VBP indicated by the reference tearing effect control signal TE is placed before the vertical blank end point of the vertical blank period SVBP of the slave display module SDM in the current frame (as indicated by 1ST FRAME), the slave display module SDM may decrease the vertical blank period SVBP of the slave display module SDM in the next frame (as indicated by 2ND FRAME). Accordingly, the slave display module SDM may operate based on the adjusted vertical blank period MVBP. Here, the slave display module SDM may count the interval DIF between the vertical blank end point of the vertical blank period SVBP of the slave display module SDM and the reference vertical blank end point of the reference vertical blank period VBP (i.e., the vertical blank period VBP of the master display module MDM) with the internal clock signal, and may decrease the vertical blank period SVBP of the slave display module SDM based on the interval DIF. A period in which a frame scan is not completed in the current frame (as indicated by SCAN-FAIL) may exist. However, because a blank image is displayed or output at the beginning of the operation of the slave display module SDM, a user may not perceive the period SCAB-FAIL in which the frame scan is not completed. Further, because the operation of the slave display module SDM is immediately restored (e.g., the vertical blank period SVBP is decreased) in the next frame, the adjustment may not result in any perceivable problem in the displayed image.

In an example embodiment, the slave display module SDM may generate the adjusted vertical blank period MVBP by decreasing the vertical blank period SVBP of the slave display module SDM by more than the number of counted clocks of the internal clock signal. Here, the slave display module SDM may decrease the vertical blank period SVBP of the slave display module SDM to control the vertical blank end point of the adjusted vertical blank period MVBP to be placed at the reference vertical blank end point of the reference vertical blank period VBP or before the reference vertical blank end point of the reference vertical blank period VBP. For example, the vertical blank period VBP of the master display module and the vertical blank period SVBP of the slave display module SDM may include a front porch, a vertical synchronization width, and a back porch, respectively. In one example embodiment, when the slave display module SDM generates the adjusted vertical blank period MVBP, the slave display module SDM may decrease its vertical blank period SVBP by reducing the number of clocks of the internal clock signal allocated to the front porch and/or the back porch of its vertical blank period SVBP. In another example embodiment, the slave display module SDM may generate the adjusted vertical blank period MVBP by decreasing the vertical blank period SVBP of the slave display module SDM by decreasing the horizontal blank period of the slave display module SDM. Here, the slave display module SDM may decrease the vertical blank period SVBP of the slave display module SDM to control the vertical blank end point of the adjusted vertical blank period MVBP to be placed at the reference vertical blank end point of the reference vertical blank period VBP or before the reference vertical blank end point of the reference vertical blank period VBP. For example, the vertical blank period (e.g., VBP and SVBP) includes Q horizontal blank periods, where Q is an integer greater than or equal to 1, and the horizontal blank period includes a front porch, a horizontal synchronization width, and a back porch. Thus, when the slave display module SDM generates the adjusted vertical blank period MVBP, the slave display module SDM may decrease its vertical blank period SVBP by reducing the number of clocks of the internal clock signal allocated to, for example, the front porch and/or the back porch of its horizontal blank period.

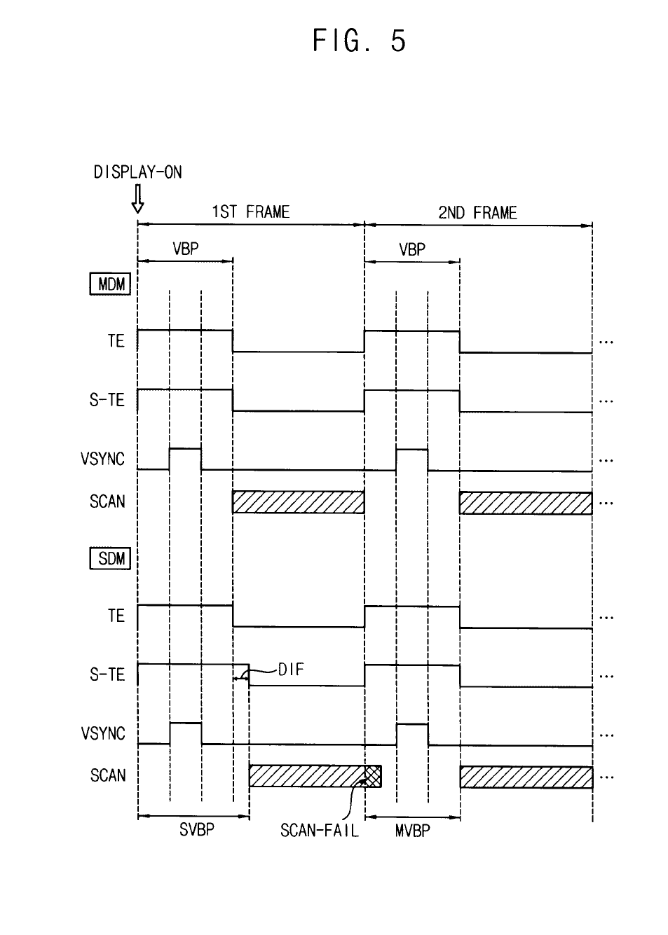

FIG. 6 is a timing diagram illustrating an example in which a slave display module maintains a vertical blank period in the multi-display device of FIG. 1.

Referring to FIG. 6, the tearing effect control signal S-TE of the master display module MDM (e.g., the reference tearing effect control signal TE) may correspond to the vertical blank period VBP of the master display module MDM (e.g., the reference vertical blank period VBP). Further, the tearing effect control signal S-TE of the slave display module SDM may correspond to the vertical blank period SVBP of the slave display module SDM. Thus, the reference vertical blank period VBP (e.g., the reference vertical blank start point and the reference vertical blank end point) may be obtained from the reference tearing effect control signal TE (e.g., the tearing effect control signal S-TE of the master display module MDM). Further, the vertical blank period SVBP of the slave display module SDM (e.g., the vertical blank start point and the vertical blank end point) may be obtained from the tearing effect control signal S-TE of the slave display module SDM. FIG. 6 shows an example in which the internal clock signal of the master display module MDM (e.g., a clock signal generated by an internal oscillator included in the master display module MDM) is relatively slow and the internal clock signal of the slave display module SDM (e.g., a clock signal generated by an internal oscillator included in the slave display module) is relatively fast.

For example, when the reference vertical blank end point of the reference vertical blank period VBP indicated by the reference tearing effect control signal TE is placed after the vertical blank end point of the vertical blank period SVBP of the slave display module SDM (e.g., the vertical blank end point of the vertical blank period SVBP of the slave display module SDM is placed at the reference vertical blank end point of the reference vertical blank period VBP or before the reference vertical blank end point of the reference vertical blank period VBP) in a current frame (as indicated by 1ST FRAME), the slave display module SDM may maintain the vertical blank end point of the vertical blank period SVBP of the slave display module SDM in a next frame (as indicated by 2ND FRAME). In other words, when the reference vertical blank end point of the reference vertical blank period VBP indicated by the reference tearing effect control signal TE is placed after the vertical blank end point of the vertical blank period SVBP of the slave display module SDM in the current frame (as indicated by 1ST FRAME), the slave display module SDM may maintain the vertical blank period SVBP of the slave display module SDM in the next frame (as indicated by 2ND FRAME). Accordingly, the slave display module SDN may continue to operate based on its vertical blank period SVBP. That is, the interval DIF between the vertical blank end point of the vertical blank period SVBP of the slave display module SDM and the reference vertical blank end point of the reference vertical blank period VBP (e.g., the vertical blank period VBP of the master display module MDM) may be maintained. Even when the host controller of the multi-display device adjusts the data transmission timing based on the reference tearing effect control signal TE output from the master display module MDM, the internal clock signal of the slave display module SDM may be faster than the internal clock signal of the master display module MDM. Thus, when the slave display module SDM continues to operate based on its vertical blank period SVBP, the tearing effect may not occur between the master display module MDM and the slave display modules SDM or between the slave display modules SDM.

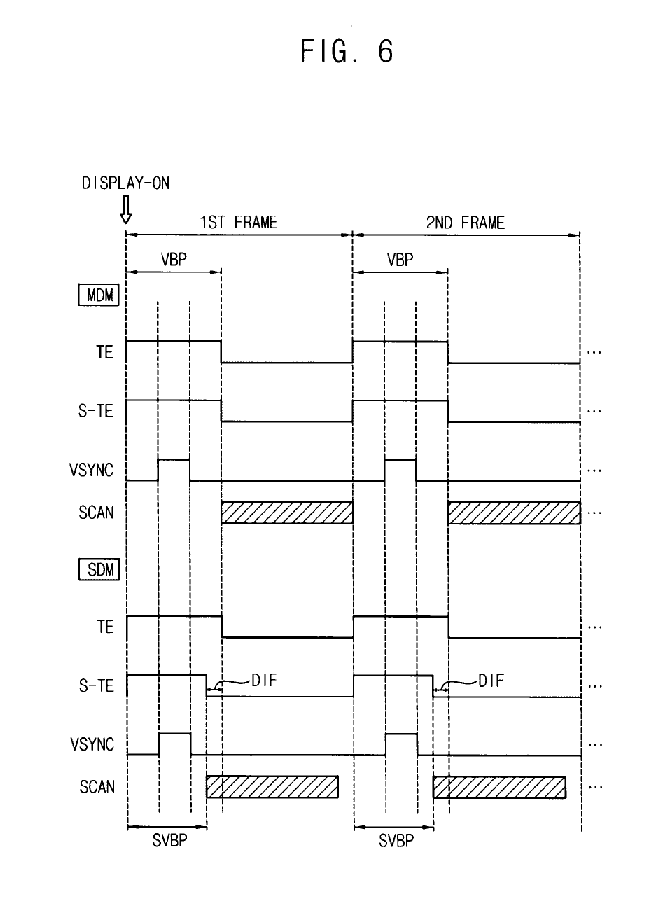

FIG. 7 is a timing diagram illustrating an example in which a slave display module increases a vertical blank period in the multi-display device of FIG. 1.

Referring to FIG. 7, the tearing effect control signal S-TE of the master display module MDM (i.e., the reference tearing effect control signal TE) may correspond to the vertical blank period VBP of the master display module MDM (e.g., the reference vertical blank period VBP). Further, the tearing effect control signal S-TE of the slave display module SDM may correspond to the vertical blank period SVBP of the slave display module SDM. Thus, the reference vertical blank period VBP (e.g., the reference vertical blank start point and the reference vertical blank end point) may be obtained from the reference tearing effect control signal TE (e.g., the tearing effect control signal S-TE of the master display module MDM). Further, the vertical blank period SVBP of the slave display module (e.g., the vertical blank start point and the vertical blank end point) may be obtained from the tearing effect control signal S-TE of the slave display module SDM. FIG. 7 shows an example in which the internal clock signal of the master display module MDM (e.g., a clock signal generated by an internal oscillator included in the master display module MDM) is relatively slow and the internal clock signal of the slave display module SDM (e.g., a clock signal generated by an internal oscillator included in the slave display module SDM) is relatively fast.

For example, when the reference vertical blank end point of the reference vertical blank period VBP indicated by the reference tearing effect control signal TE is placed after the vertical blank end point of the vertical blank period SVBP of the slave display module SDM (e.g., the vertical blank end point of the vertical blank period SVBP of the slave display module SDM is placed before the reference vertical blank end point of the reference vertical blank period VBP) in a current frame (as indicated by 1ST FRAME), the slave display module SDM may move the vertical blank end point of the vertical blank period SVBP of the slave display module SDM to a selection point that precedes the reference vertical blank end point of the reference vertical blank period VBP by a desired (or alternatively, predetermined) distance in a next frame (as indicated by 2ND FRAME). In other words, when the reference vertical blank end point of the reference vertical blank period VBP indicated by the reference tearing effect control signal TE is placed after the vertical blank end point of the vertical blank period SVBP of the slave display module SDM in the current frame (as indicated by 1ST FRAME), the slave display module SDM may increase its vertical blank period SVBP in the next frame (as indicated by 2ND FRAME) as long as the vertical blank end point of its vertical blank period SVBP is placed before the reference vertical blank end point of the reference vertical blank period VBP. Accordingly, the slave display module SDM may operate based on the adjusted vertical blank period MVBP. That is, the interval DIF between the vertical blank end point of the vertical blank period SVBP of the slave display module SDM and the reference vertical blank end point of the reference vertical blank period VBP may be changed (e.g., reduced) to an interval MDIF between the vertical blank end point of the adjusted vertical blank period MVBP of the slave display module SDM and the reference vertical blank end point of the reference vertical blank period VBP. As described above, although the vertical blank end point of the vertical blank period SVBP of the slave display module SDM is placed before the reference vertical blank end point of the reference vertical blank period VBP in the current frame, if the difference between them is longer than a distance corresponding to the desired (or alternatively, predetermined) number of clocks of the internal clock signal, the slave display module SDM may increase its vertical blank period SVBP as long as the vertical blank end point of its vertical blank period SVBP is placed before the reference vertical blank end point of the reference vertical blank period VBP.

In an example embodiment, the slave display module SDM may generate the adjusted vertical blank period MVBP by increasing the vertical blank period SVBP of the slave display module SDM. Here, the slave display module SDM may move the vertical blank end point of the adjusted vertical blank period MVBP to the selection point that precedes the reference vertical blank end point of the reference vertical blank period VBP by the desired (or alternatively, predetermined) distance. For example, the vertical blank period VBP of the master display module MDM and the vertical blank period SVBP of the slave display module SDM may include a front porch, a vertical synchronization width, and a back porch, respectively. Thus, when the slave display module SDM generates the adjusted vertical blank period MVBP, the slave display module SDM may increase its vertical blank period SVBP by increasing the number of clocks of the internal clock signal allocated to the front porch and/or the back porch of its vertical blank period SVBP. In another example embodiment, the slave display module SDM may generate the adjusted vertical blank period MVBP by increasing the vertical blank period SVBP of the slave display module SDM by increasing the horizontal blank period of the slave display module SDM. Here, the slave display module SDM may move the vertical blank end point of the adjusted vertical blank period MVBP to the selection point that precedes the reference vertical blank end point of the reference vertical blank period VBP by the desired (or alternatively, predetermined) distance. For example, the vertical blank period (e.g., VBP and SVBP) includes Q horizontal blank periods, where Q is an integer greater than or equal to 1, and the horizontal blank period includes a front porch, a horizontal synchronization width, and a back porch. Thus, when the slave display module SDM generates the adjusted vertical blank period MVBP, the slave display module SDM may increase its vertical blank period SVBP by increasing the number of clocks of the internal clock signal allocated to the front porch and/or the back porch of its horizontal blank period.

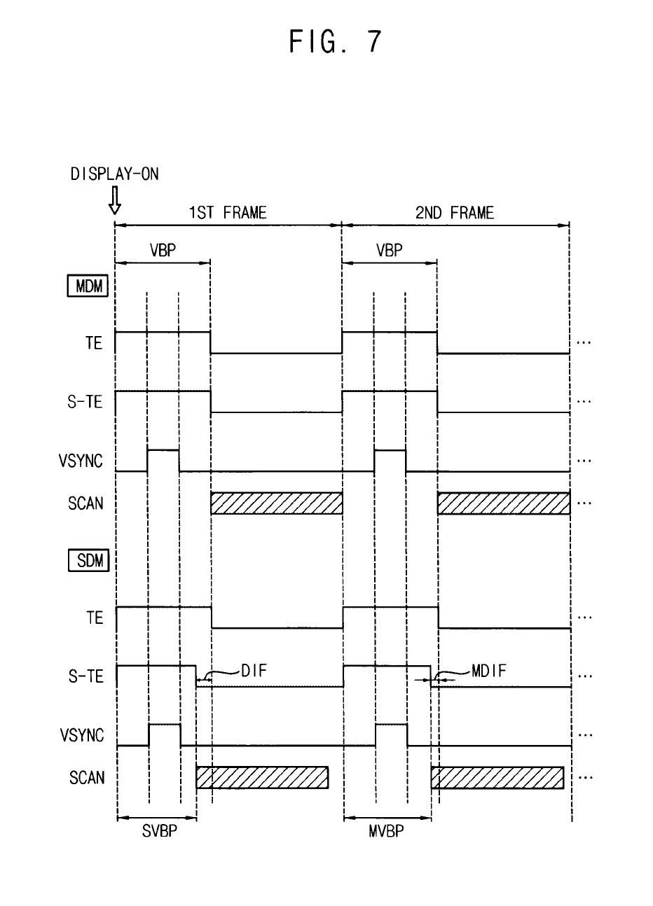

FIG. 8 is a flowchart illustrating an example in which a slave display module moves a vertical blank end point of a vertical blank period in the multi-display device of FIG. 1.

Referring to FIG. 8, the slave display module may move the vertical blank end point of the vertical blank period based on the reference tearing effect control signal output from the master display module. For example, the slave display module may count an interval between the vertical blank end point of its vertical blank period and the reference vertical blank end point of the reference vertical blank period with an internal clock signal (S220). Then, the slave display module may adjust its vertical blank period based on the number of counted clocks of the internal clock signal (S240). For example, when the internal clock signal of the master display module is relatively fast and the internal clock signal of the slave display module is relatively slow, the reference vertical blank end point of the reference vertical blank period indicated by the reference tearing effect control signal may be placed before the vertical blank end point of the vertical blank period of the slave display module. Thus, the slave display module may count clocks of the internal clock signal from the reference vertical blank end point of the reference vertical blank period to the vertical blank end point of its vertical blank period and may decrease its vertical blank period based on the number of counted clocks of the internal clock signal. When the internal clock signal of the master display module is relatively slow, the internal clock signal of the slave display module is relatively fast, and a difference between them is greater than the desired (or alternatively, predetermined) number of clocks of the internal clock signal, the reference vertical blank end point of the reference vertical blank period indicated by the reference tearing effect control signal may be placed after the vertical blank end point of the vertical blank period of the slave display module. Thus, the slave display module may count clocks of the internal clock signal from the vertical blank end point of its vertical blank period to the reference vertical blank end point of the reference vertical blank period and may increase its vertical blank period based on the number of counted clocks of the internal clock signal as long as the vertical blank end point of its vertical blank period is placed before the reference vertical blank end point of the reference vertical blank period. In some example embodiments, when the internal clock signal of the master display module is relatively slow, the internal clock signal of the slave display module is relatively fast, and the difference between them is smaller than the desired (or alternatively, predetermined) number of clocks of the internal clock signal, the slave display module may maintain its vertical blank period.

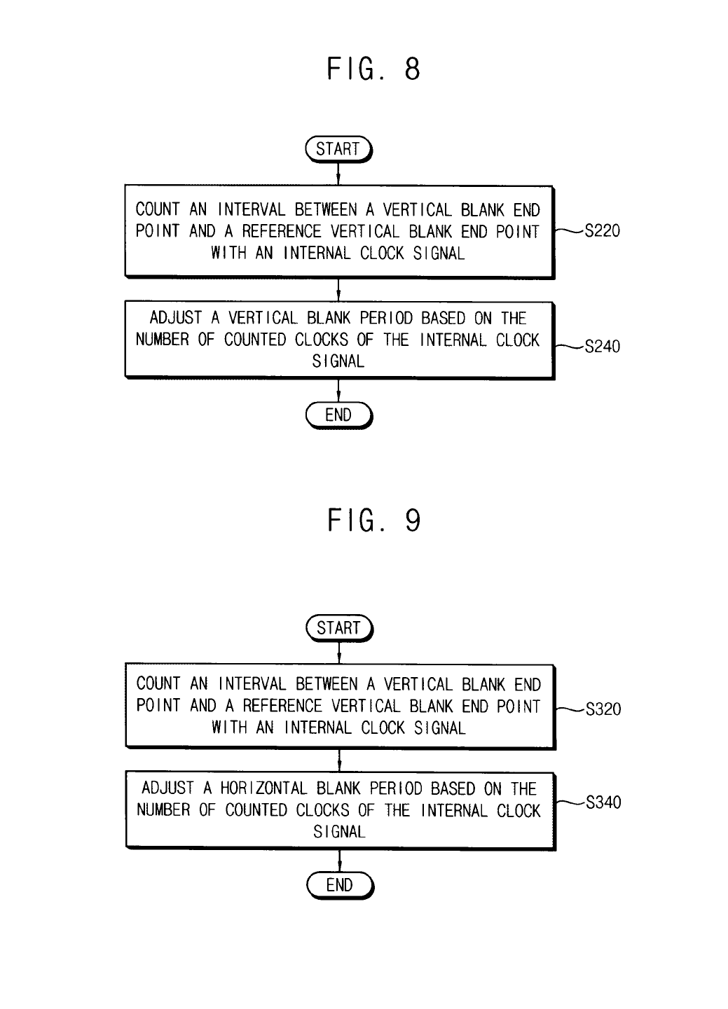

FIG. 9 is a flowchart illustrating another example in which a slave display module moves a vertical blank end point of a vertical blank period in the multi-display device of FIG. 1.

Referring to FIG. 9, the slave display module may move the vertical blank end point of the vertical blank period based on the reference tearing effect control signal output from the master display module. For example, the slave display module may count an interval between the vertical blank end point of its vertical blank period and the reference vertical blank end point of the reference vertical blank period with an internal clock signal (S320). Then, the slave display module may adjust its horizontal blank period based on the number of counted clocks of the internal clock signal (S340). As described above, because the vertical blank period of the slave display module includes Q horizontal blank periods, where Q is an integer greater than or equal to 1, the vertical blank period of the slave display module may be decreased as the horizontal blank period of the slave display module is decreased. For example, when the internal clock signal of the master display module is relatively fast and the internal clock signal of the slave display module is relatively slow, the reference vertical blank end point of the reference vertical blank period indicated by the reference tearing effect control signal may be placed before the vertical blank end point of the vertical blank period of the slave display module. Thus, the slave display module may count clocks of the internal clock signal from the reference vertical blank end point of the reference vertical blank period to the vertical blank end point of its vertical blank period and may decrease its horizontal blank period based on the number of counted clocks of the internal clock signal. When the internal clock signal of the master display module is relatively slow, the internal clock signal of the slave display module is relatively fast, and a difference between them is greater than the desired (or alternatively, predetermined) number of clocks of the internal clock signal, the reference vertical blank end point of the reference vertical blank period indicated by the reference tearing effect control signal may be placed after the vertical blank end point of the vertical blank period of the slave display module. Thus, the slave display module may count clocks of the internal clock signal from the vertical blank end point of its vertical blank period to the reference vertical blank end point of the reference vertical blank period and may increase its horizontal blank period based on the number of counted clocks of the internal clock signal as long as the vertical blank end point of its vertical blank period is placed before the reference vertical blank end point of the reference vertical blank period. In some example embodiments, when the internal clock signal of the master display module is relatively slow, the internal clock signal of the slave display module is relatively fast, and the difference between them is smaller than the desired (or alternatively, predetermined) number of clocks of the internal clock signal, the slave display module may maintain its vertical blank period by maintaining its horizontal blank period.

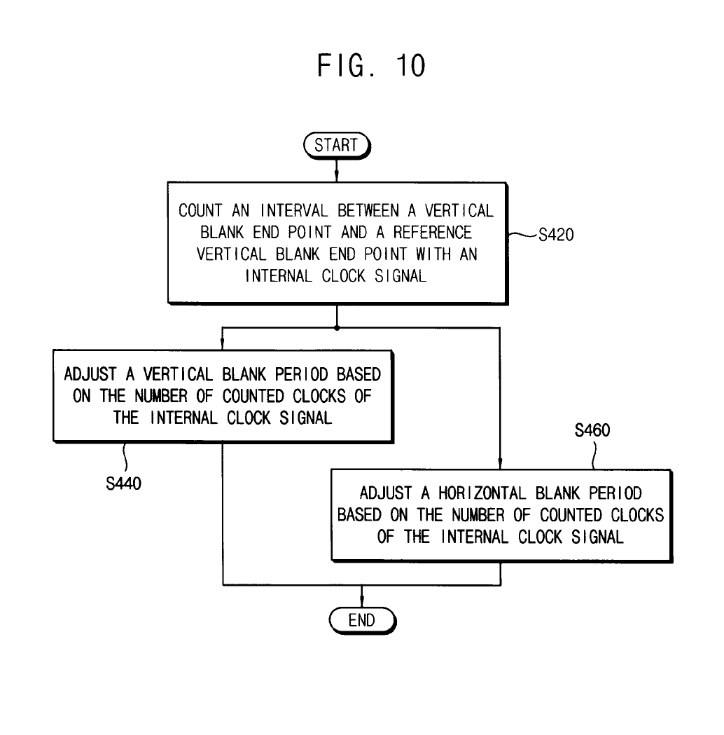

FIG. 10 is a flowchart illustrating still another example in which a slave display module moves a vertical blank end point of a vertical blank period in the multi-display device of FIG. 1.

Referring to FIG. 10, the slave display module may move the vertical blank end point of the vertical blank period based on the reference tearing effect control signal output from the master display module. For example, the slave display module may count an interval between the vertical blank end point of its vertical blank period and the reference vertical blank end point of the reference vertical blank period with an internal clock signal (S420). Then, the slave display module may adjust its vertical blank period based on the number of counted clocks of the internal clock signal (S440), and/or may adjust its horizontal blank period based on the number of counted clocks of the internal clock signal (S460). For example, when the internal clock signal of the master display module is relatively fast and the internal clock signal of the slave display module is relatively slow, the reference vertical blank end point of the reference vertical blank period indicated by the reference tearing effect control signal may be placed before the vertical blank end point of the vertical blank period of the slave display module. Thus, the slave display module may count clocks of the internal clock signal from the reference vertical blank end point of the reference vertical blank period to the vertical blank end point of its vertical blank period, may decrease its vertical blank period based on the number of counted clocks of the internal clock signal, and/or may decrease its horizontal blank period based on the number of counted clocks of the internal clock signal. When the internal clock signal of the master display module is relatively slow, the internal clock signal of the slave display module is relatively fast, and a difference between them is greater than the desired (or alternatively, predetermined) number of clocks of the internal clock signal, the reference vertical blank end point of the reference vertical blank period indicated by the reference tearing effect control signal may be placed after the vertical blank end point of the vertical blank period of the slave display module. Thus, the slave display module may count clocks of the internal clock signal from the vertical blank end point of its vertical blank period to the reference vertical blank end point of the reference vertical blank period and may increase its vertical blank period and/or its horizontal blank period based on the number of counted clocks of the internal clock signal as long as the vertical blank end point of its vertical blank period is placed before the reference vertical blank end point of the reference vertical blank period. In some example embodiments, when the internal clock signal of the master display module is relatively slow, the internal clock signal of the slave display module is relatively fast, and the difference between them is smaller than the desired (or alternatively, predetermined) number of clocks of the internal clock signal, the slave display module may maintain its vertical blank period and/or the horizontal blank period.

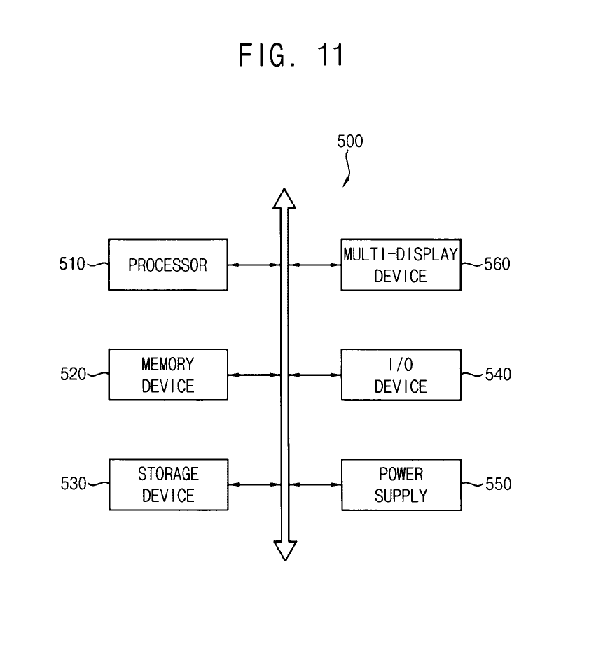

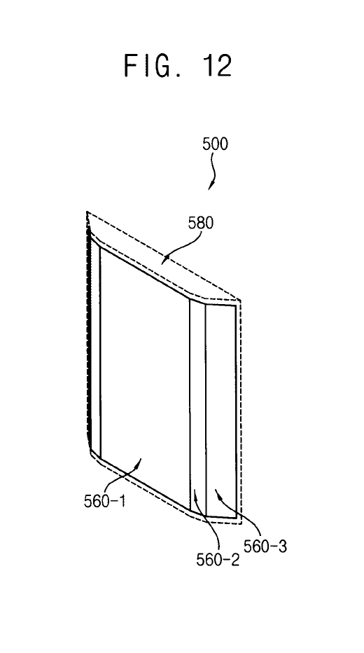

FIG. 11 is a block diagram illustrating an electronic device according to an example embodiment. FIG. 12 is a diagram illustrating an example in which the electronic device of FIG. 11 is implemented as a smart phone.

Referring to FIGS. 11 and 12, the electronic device 500 may include a processor 510, a memory device 520, a storage device 530, an input/output (I/O) device 540, a power supply 550, and a multi-display device 560. Here, the multi-display device 560 may correspond to the multi-display device 100 of FIG. 1. In some example embodiments, the multi-display device 560 may be implemented as a liquid crystal display device, an organic light emitting display device, etc. The electronic device 500 may further include a plurality of ports for communicating with a video card, a sound card, a memory card, a universal serial bus (USB) device, other electronic devices, etc. In an example embodiment, as illustrated in FIG. 12, the electronic device 500 may be implemented as a smart phone. In this case, the electronic device 500 may include a body 580 and the multi-display device 560 (as indicated by 560-1, 560-2, and 560-3). Here, the body 580 may include the processor 510, the memory device 520, the storage device 530, the I/O device 540, the power supply 550, etc. The multi-display device 560 may include a plurality of display modules 560-1, 560-2, and 560-3. However, the electronic device 500 is not limited thereto. That is, the electronic device 500 may be any electronic device including the multi-display device 560. For example, the electronic device 500 may be implemented as a cellular phone, a smart pad, a tablet PC, a personal digital assistant (PDA), a portable multimedia player (PMP), etc.

The processor 510 may perform various computing functions. In some example embodiments, the processor 510 may be a micro-processor, a central processing unit (CPU), an application processor, etc. The processor 510 may be connected to other components (e.g., the memory device 520, the storage device 530, the I/O device 540, the multi-display device 560, etc.) via an address bus, a control bus, a data bus, etc. In some example embodiments, the processor 510 may be connected to an extended bus such as a peripheral component interconnection (PCI) bus. The memory device 520 may store data for an operation of the electronic device 500. For example, the memory device 520 may include a volatile memory device such as a dynamic random access memory (DRAM) device, a static random access memory (SRAM) device, a mobile DRAM device, etc., and/or a non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. The storage device 530 may include a solid state drive (SSD) device, a hard disk drive (HDD) device, a CD-ROM device, etc.

The I/O device 540 may include an input device such as a keyboard, a keypad, a touchpad, a touch-screen, a mouse device, etc., and an output device such as a printer, a speaker, etc. In some example embodiments, the multi-display device 560 may be included in the I/O device 540. The power supply 550 may provide power for the operation of the electronic device 500. The multi-display device 560 may be connected to other components via the buses or other communication links. As described above, the multi-display device 560 may include display modules and a host controller that controls the display modules. Each of the display modules may include a display panel and a display driving integrated circuit. Each of the display modules may perform a display panel self-refresh operation. In some example embodiments, the display modules may be classified into a master display module and slave display modules. Here, the host controller may provide the display modules with image data for displaying an image. Further, each of the slave display modules may adjust its vertical blank period based on a reference tearing effect control signal that is received from the master display module. For example, each of the slave display modules may set a vertical blank start point of its vertical blank period to be a reference vertical blank start point indicated by the reference tearing effect control signal, may compare a vertical blank end point of its vertical blank period with a reference vertical blank end point indicated by the reference tearing effect control signal in each frame, and may count an interval between the vertical blank end point of its vertical blank period and the reference vertical blank end point of the reference vertical blank period with an internal clock signal.

Here, each of the slave display modules may move the vertical blank end point of its vertical blank period to be placed at the reference vertical blank end point of the reference vertical blank period or before the reference vertical blank end point of the reference vertical blank period in a (k+1)th frame when the vertical blank end point of its vertical blank period is placed after the reference vertical blank end point of the reference vertical blank period in a (k)th frame. In an example embodiment, each of the slave display modules may maintain the vertical blank end point of its vertical blank period in the (k+1)th frame when the vertical blank end point of its vertical blank period is placed at the reference vertical blank end point of the reference vertical blank period or before the reference vertical blank end point of the reference vertical blank period in the (k)th frame. In another example embodiment, each of the slave display modules may move the vertical blank end point of its vertical blank period to a selection point that precedes the reference vertical blank end point of the reference vertical blank period by a desired (or alternatively, predetermined) distance in the (k+1)th frame when the vertical blank end point of its vertical blank period is placed before the reference vertical blank end point of the reference vertical blank period in the (k)th frame. Because these operations are previously described in detail, duplicated description will not be repeated. In brief, the multi-display device 560 may include the display modules each including the display panel and the display driving integrated circuit and the host controller that controls the display modules. Here, the multi-display device 560 may mitigate or prevent a tearing effect from occurring between the display modules without changing an interface between the host controller and the display modules and by adjusting the vertical blank periods of the slave display modules (e.g., by ensuring a sufficient vertical blank period required for frame synchronization between the display modules) based on the reference tearing effect control signal received from the master display module selected from among the display modules.

The present inventive concepts may be applied to a multi-display device and an electronic device including the multi-display device. For example, the present inventive concepts may be applied to a computer, a laptop, a digital camera, a cellular phone, a smart phone, a smart pad, a tablet PC, a personal digital assistants, a portable multimedia player, a car navigation system, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concepts. Accordingly, all such modifications are intended to be included within the scope of the present inventive concepts as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A multi-display device comprising:
a plurality of display modules including a plurality of display panels and a plurality of display driving integrated circuits, respectively, the plurality of display modules configured to perform a display panel self-refresh operation, one of the display modules being a master display module and the rest of the display modules being slave display modules, the slave display modules configured to adjust a vertical blank period thereof based on a reference tearing effect control signal output from the master display module; and
a host controller configured to control the display modules and provide image data to the display modules.

2. The device of claim 1, wherein the master display module is selected from among the display modules based on a master selection signal received from an external component or an algorithm, which is stored in a non-transitory computer-readable medium and is configured to be executed by a processor.

3. The device of claim 2, wherein each of the display modules is configured to generate a tearing effect control signal and includes an input/output terminal for sharing the tearing effect control signal among the display modules, and
wherein the tearing effect control signal generated by the master display module from among the display modules is determined as the reference tearing effect control signal.

4. The device of claim 3, wherein the master display module is configured to perform a display operation and some or all of the slave display modules is configured to perform the display operation when the multi-display device operates.

5. The device of claim 1, wherein each of the slave display modules is configured to set a vertical blank start point of the vertical blank period to be a reference vertical blank start point indicated by the reference tearing effect control signal.

6. The device of claim 5, wherein each of the slave display modules is configured to compare a vertical blank end point of the vertical blank period with a reference vertical blank end point indicated by the reference tearing effect control signal in each frame, and count an interval between the vertical blank end point and the reference vertical blank end point with an internal clock signal.

7. The device of claim 6, wherein each of the slave display modules is configured to move the vertical blank end point to be placed before the reference vertical blank end point in a (k+1)th frame, where k is an integer greater than or equal to 1, when the vertical blank end point is placed after the reference vertical blank end point in a (k)th frame.

8. The device of claim 6, wherein each of the slave display modules is configured to move the vertical blank end point to be placed at the reference vertical blank end point or before the reference vertical blank end point by decreasing the vertical blank period by more than a number of counted clocks of the internal clock signal.

9. The device of claim 6, wherein each of the slave display modules is configured to move the vertical blank end point to be placed at the reference vertical blank end point or before the reference vertical blank end point by decreasing the vertical blank period by decreasing a horizontal blank period.

10. The device of claim 6, wherein each of the slave display modules is configured to maintain the vertical blank end point in a (k+1)th frame, where k is an integer greater than or equal to 1, when the vertical blank end point is placed at the reference vertical blank end point or before the reference vertical blank end point in a (k)th frame.

11. The device of claim 6, wherein each of the slave display modules is configured to move the vertical blank end point to a selection point that precedes the reference vertical blank end point by a distance in a (k+1)th frame, where k is an integer greater than or equal to 1, when the vertical blank end point is placed before the reference vertical blank end point in a (k)th frame.

12. The device of claim 11, wherein each of the slave display modules is configured to move the vertical blank end point to the selection point by increasing the vertical blank period.

13. The device of claim 11, wherein each of the slave display modules is configured to move the vertical blank end point to the selection point by increasing the vertical blank period by increasing a horizontal blank period.

14. The device of claim 1, wherein the multi-display device is configured to operate based on a point-to-point interface, which enables the host controller to separately provide the image data to the display modules.

15. The device of claim 1, wherein the multi-display device is configured to operate based on a multi-drop interface, which enables the host controller to concurrently provide the image data to the display modules.

16. A multi-display device including a plurality of display modules configured to perform a display panel self-refresh operation, the display modules each including a display panel and a display driving integrated circuit, the multi-display device comprising:
a master display module selected from among the display modules, the master display module configured to output a reference tearing effect control signal;
at least one slave display module configured to adjust a vertical blank period based on the reference tearing effect control signal; and
a host controller configured to control the display modules and provide image data to the display modules,

17. The multi-display device of claim 16, wherein the master display module is selected from among the display modules based on a master selection signal received from an external component or an algorithm, which is stored in a non-transitory computer-readable medium and is configured to be executed by a processor.

18. The multi-display device of claim 16, wherein the at least one slave display module is configured to,
set a vertical blank start point of the vertical blank period to be a reference vertical blank start point indicated by the reference tearing effect control signal,
compare a vertical blank end point of the vertical blank period with a reference vertical blank end point indicated by the reference tearing effect control signal in each frame,
count an interval between the vertical blank end point and the reference vertical blank end point with an internal clock signal, and
at least one of move and maintain the vertical blank end point in a (k+1)th frame, where k is an integer greater than or equal to 1, with respect to the reference vertical blank end point depending on whether the vertical blank end point is placed before, at, or after the reference vertical blank end point in a (k)th frame.

19. The multi-display device of claim 18, wherein when the vertical blank end point is placed before the reference vertical blank end point in the (k)th frame, the at least one slave display module is configured to move the vertical blank end point to a selection point, which precedes the reference vertical blank end point, in the (k+1)th frame by one of increasing the vertical blank period and increasing the vertical blank period by increasing a horizontal blank period.

20. The multi-display device of claim 18, wherein when the interval in the (k)th frame is smaller than a threshold value, the at least one slave display module is configured to maintain the vertical blank period in the (k+1)th frame.
